(19) United States
(12) Patent Application Publication
(10) Pub. No.: US 2021/0163268 A1
(43) Pub. Date: Jun. 3, 2021

(54) A METHOD OF HANDLING A WIND TURBINE COMPONENT AND A WIND TURBINE WITH A CRANE

(71) Applicant: Vestas Wind Systems A/S, Aarhus N. (DK)

(72) Inventors: Torben Ladegaard Baun, Skødstrup (DK); Jesper Lykkegaard Neubauer, Hornslet (DK); Jonas Lerche Schomacker, Solrød Strand (DK); Brian Jørgensen, Galten (DK); Leif Christoffersen, Vejle Øst (DK)

(21) Appl. No.: 16/771,384

(22) PCT Filed: Dec. 21, 2018
(86) PCT No.: PCT/DK2018/050421

§ 371 Date: Jun. 10, 2020

(30) Foreign Application Priority Data
Dec. 22, 2017 (DK) PA 2017 71023

(51) Int. Cl. B66C 1/10; B66C 23/20; F03D 1/02; F03D 13/10

(52) U.S. Cl. CPC B66C 1/108; B66C 23/207; F05B 2230/61; F03D 13/10; F03D 1/02

(57) ABSTRACT

A method of handling a wind turbine component (112) in a wind turbine (101) comprising a tower (102) extending in an upwards direction, a load carrying structure (103, 103′, 103″) fixed to the tower and extending in an outwards direction transverse to the upwards direction. According to the method, a crane (21) with a fixation structure (22) is provided and raised to the level of the load carrying structure by use of a hoisting rope. Once in position, the crane is used for handling the wind turbine component.

### FIELD OF THE INVENTION

The disclosure relates to a method of handling a wind turbine component in a wind turbine. Particularly, the method relates to a wind turbine comprising a tower extending in an upwards direction, a load carrying structure extending in an outwards direction and being fixed to the tower, and an energy generating unit fixed to the load carrying structure. Such structures are typically seen in multiple rotor wind turbines. In such wind turbines, the outwards direction is transverse to the upwards direction.

The invention further relates to a lifting system and a crane for handling wind turbine components.

### BACKGROUND OF THE INVENTION

In wind turbines, wind energy is converted into mechanical energy by blades carried by a hub. The hub may be carried by a shaft. The size and weight of the wind turbine tower, nacelle, blades, and drive train have increased over the years and manufacturing, transport, and assembly of the wind turbines have become more and more challenging.

Modern wind turbines may include towers which are more than 100 meters tall.

In multirotor wind turbines the energy generating units may be carried by a load carrying structure which, in turn, is connected to a tower.

A conventional approach for assembly of wind turbines, and particularly the nacelle, includes lifting the components by use of an external crane, e.g. a mobile crane or a floating crane.

Since external crane operations are expensive, the nacelle is sometimes fitted with an internal crane which, once the nacelle is installed, can be used for servicing and minor repair, e.g. for hoisting spare parts from the ground into the nacelle. However, for cost optimization, such integrated cranes are normally small and lacks the capacity to handle large or heavy wind turbine components.

### DESCRIPTION OF THE INVENTION

It is an object of the present disclosure to reduce costs in handling wind turbine components, and particularly to facilitate the assembly of wind turbines.

According to these and other objects, the disclosure, in a first aspect, provides a method of handling a wind turbine component in a multiple rotor wind turbine, the method comprising:
providing a crane with a fixation structure configured for fixing the crane to an attachment point on the load carrying structure or on to the energy generating unit,
using a lifting rope attached to the load carrying structure or to the energy generating unit for hoisting the crane to the attachment point,
attaching the fixation structure of the crane to the attachment point, and
using the crane to handle the wind turbine component.

In a second aspect, the disclosure provides a wind turbine with a crane.

Due to the crane, time and money can be saved during the installation of the wind turbine. Particularly, the use of a lifting rope for mounting the crane to the attachment point enables the use of the crane for mounting e.g. the energy generating unit and other large components. This enables assembly of the wind turbine without the use of external cranes.

The method may e.g. be applied for mounting a component when erecting the wind turbine or for dismounting or replacing a component during repair or servicing. The mounting or dismounting may include positioning or dispositioning for removing the wind turbine component completely or in parts. The component could e.g. be a part of a drive train, e.g. a rotor shaft, a gear box, a generator, a hub, or a blade for the hub.

In the present context, the term ‘multirotor wind turbine’ should be interpreted to mean a wind turbine comprising two or more rotors or energy generating units mounted on one tower. The load carrying structure is arranged for supporting at least one of the at least two energy generating units and for being connected to a tower of the multirotor wind turbine.

The load carrying structure may be configured for self supporting carrying of the energy generating unit, or it may be configured for being further stiffened or stabilised by additional structures such as tension elements such as guy wires etc. One or more guy wires could be attached during use of the crane, and in one embodiment, they could be removed when the crane is removed or they are left on the wind turbine to support the load carrying structure even when the crane is removed.

Accordingly, the load carrying structure forms a connection between the one or more energy generating units and the tower, and is capable of handling the loads involved with carrying the at least one energy generating unit. Particularly, the load carrying structure may be constituted by a first component and a second component, the components being structurally different. The first component may e.g. be a lightweight component, e.g. a hollow component, a lattice structure or similar relatively light weight structure constituting the largest part of the load carrying structure. The first component may e.g. be a tube. The second component may be arranged as a termination of the first component at the free end furthest away from the tower. The second component could be relatively heavy compared to the first component, and it may e.g. be constituted by a casted component. Particularly, the second component may have a higher rigidity, strength, or hardness than the first component. The second component may be referred to as the ‘bell’.

The energy generating unit is typically arranged at or near the end of the load carrying structure. By the abovementioned first and second components constituting the load carrying structure, the energy generating unit may particularly be fixed to the second component, the bell, either directly or via an adapter.

Typically, two load carrying structures are arranged on opposite sides of the tower to thereby balance forces and loads with respect to the tower. The energy generating units may be arranged at extremities of the load carrying structures, i.e. furthest away from the tower.

The load carrying structure may be attached to the tower via a yaw arrangement whereby the load carrying structure is allowed to perform yawing movements with respect to the tower, thereby allowing the rotors of the energy generating units to be directed into the incoming wind.

In the present context the term ‘energy generating unit’ should be interpreted to mean a part of the wind turbine which transforms the energy of the wind into electrical energy. Normally, this constitutes a nacelle and a rotor.

In the present context the term ‘tower’ should be interpreted to mean a substantially vertical structure, arranged to carry the energy generating units of the multirotor wind turbine, at least partly via one or more load carrying structures. One or more energy generating units could be mounted directly on the tower.

The load carrying structure may particularly be constituted by a compression element which is carried by a tension element. The compression element may e.g. be a rigid tubular steel element or a steel element with any alternative shape making it suitable for compensation of compressive forces. The tension element could be a rod or wire forming a guy wire extending between the tower and the load carrying structure. As mentioned above, the compression element may comprise a first and a second component.

The outwards direction of the load carrying structure could be perpendicular to the upwards direction of the tower, or it could be a direction in the range of 5-25 degrees, such as 15 degrees upwards relative to perpendicular, i.e. pointing upwards.

The crane could be released from the attachment point and removed from the wind turbine once handling of the wind turbine component is ended.

When used herein, the term ‘crane’ could be a machine of any kind and equipped with means enabling its use for hoisting and/or lowering the wind turbine component. Such means may include e.g. a jack-up arrangement and/or a crane rope powered by a lifting power structure, e.g. an electric or hydraulic winch. When used herein, the term ‘crane’ is the crane which according to the invention is lifted to the load carrying structure by the lifting rope. Other cranes are mentioned with a prefix, e.g. ‘internal crane’, ‘external crane’ etc., but the word ‘crane’ without a prefix denotes the crane lifted with the lifting rope.

In one embodiment, the lifting rope is the crane rope and can be winded in or out by the lifting power structure. In this embodiment, the crane rope which constitutes the lifting rope could be attached to an internal hoisting rope of an internal or interim crane, e.g. an internal crane which is small relative to the crane. Herein, an interim crane is a small crane attached only for the purpose of lifting the crane to the load carrying structure. The interim crane thus constitutes an internal crane once it is attached.

By use of the smaller internal crane and the internal lifting rope, the lifting rope could be lifted to the load carrying structure or to the energy generating unit by use of the internal crane. Subsequently, the lifting rope is fixed to the load carrying structure or to the energy generating unit and the crane could be lifted by the lifting rope and by use of the lifting power structure included in the crane, i.e. the crane may lift itself.

The crane may particularly be attached to an attachment point at or near the end of the load carrying structure. By the aforementioned first and second components constituting the load carrying structure, the attachment point may particularly be a point on the second component, i.e. the bell.

The term ‘rope’ should herein be interpreted as any kind of flexible tension member, e.g. in the form of a wire, a chain, or similar element. Typically, the crane includes a sheave around which the crane rope is winded and which forms a point of release for the crane rope.

The lifting rope is attached to the crane and used for lifting the crane from ground or sea level to the load carrying structure. The lifting rope could be any kind of flexible tension member, e.g. in the form of a wire, a chain, or similar element.

The lifting rope could be attached to the fixation structure, i.e. to that part of the crane which is fixed to the attachment point. Particularly, the lifting rope may be attached between the load carrying structure and the fixation structure such that the fixation structure can be lifted directly into a position which is suitable for fixing the crane to the load carrying structure. The lifting rope may also be constituted by the crane rope.

The fixation structure may e.g. be configured to interface the load carrying structure in a predetermined orientation, and the crane could be provided with a weight distribution such that it can be lifted with the lifting rope attached to the fixation structure and be in balance in an orientation, herein referred to as ‘balance orientation’, which matches the predetermined orientation. Herein ‘matches’ means that the crane, when lifted in the fixation structure, maintains an orientation in which the fixation structure can engage and be fixed to the attachment point.

The fixation structure and the attachment point may particularly facilitate geometric locking of the crane to the load carrying structure or energy generating unit. As an example, the fixation structure may include one or more projections cooperative with one or more indentations or holes on the load carrying structure, or the fixation structure may include one or more indentations or holes cooperative with one or more projections on the load carrying structure. Particularly, such projections, or indentations, or holes, could have a cross section suitable for guiding the crane into a correct position on the load carrying structure, e.g. a pyramid or conic shape of projections of the fixation structure or on the load carrying structure. Further, such projections, or indentations, or holes, could have a cross section suitable for preventing reorientation of the crane relative to the load carrying structure, e.g. a non-circular cross section.

The crane may be configured to form contact with the load carrying structure below a geometric centre of a cross section of the load carrying structure transverse to the outwards direction. Further the crane may be provided such that it extends in contact with the load carrying structure from the point below the geometric centre to a point above the geometric centre. In one embodiment, the fixation structure forms a U-shaped, a C-shaped, a horse-shoe-shaped, or a similar shaped structure which can clamp around the load carrying structure from a point below its geometric centre to a point above its geometric centre.

The crane could be provided with a hoisting point, e.g. a sheave, forming a point of suspension of the crane rope, and it could be provided such that the position of the hoisting point is movable relative to the position of the fixation structure. In one example, the crane comprises one or more elements movable relative to each other, e.g. elements linked in hinges and movable by power driven means.

The load carrying structure could be supported by a tension element in the form of a guy wire extending from the tower to a support point on the load carrying structure. The support point may typically be arranged at or near the end of the load carrying structure. By the aforementioned first and second components constituting the load carrying structure, the support point may particularly be a point on the second component, i.e. the bell.

In that way, the crane can be attached in the area where the load carrying structure is supported and the ability to handle heavy wind turbine components by use of the crane is increased while the guy wire prevents deflection of the load carrying structure.

A tagline could be connected to the crane when the crane is lifted by the lifting rope. In that way, the crane could be guided past obstacles during the hoisting procedure, e.g. if the wind turbine comprises more than one load carrying structure and the crane has to be lifted past a lower one of the load carrying structures for fixation to an upper one of the load carrying structures.

Once the crane is fixed to the attachment point, the method may be applied for lifting extension components suitable for extending the crane structure. I.e. the crane can be expanded in size or lifting capability by lifting extension components to the crane by use of the crane. In that way, the method may imply the step of, initially, lifting a relatively small or light weight crane and subsequently expanding the crane by lifting extension components.

Additionally, the method may include the use of the crane for lifting a further crane and fixing the further crane to the load carrying structure. Subsequently, the crane and the further crane may cooperate in handling the wind turbine component.

The crane could be hoisted in one single hoisting procedure and in one single piece after complete assembly of the crane at a factory or at the place where the wind turbine is assembled. Alternatively, the crane could be hoisted in several separate pieces in several subsequent hoisting procedures, and assembled on or at the load carrying structure. In one example, the fixation structure is hoisted firstly and attached to the attachment point, and further components are hoisted subsequently and attached to the fixation structure.

In a second aspect, the disclosure provides a wind turbine comprising a tower extending in an upwards direction, a load carrying structure extending in an outwards direction and being fixed to the tower, and an energy generating unit fixed to the load carrying structure, wherein the outwards direction is transverse to the upwards direction, the wind turbine further comprising a crane attached to an attachment point of the load carrying structure or on the energy generating unit.

The load carrying structure may comprise at least a first component and a second component, and the second component may form an axial termination of the first component and have a higher strength than the first component. In this embodiment, the attachment point may be a point on the second component. Further, in this embodiment, the second component could be a casted component. The second component may form a connection interface to the first component and an interface to the energy generating unit.

The wind turbine may comprise a tension element, e.g. a guy wire, extending between the tower and a support point on the second component.

In further aspects, the disclosure may provide a crane with crane rope powered by a lifting power structure which is sufficiently strong to allow the crane to lift itself.

### BRIEF DESCRIPTION OF THE DRAWINGS

The invention will now be described in further detail with reference to the accompanying drawings in which

FIG. 1 illustrates a front view of a multiple rotor wind turbine,

FIG. 2 illustrates a crane for handling wind turbine components,

FIG. 3 illustrates a load carrying structure,

FIG. 4 illustrates a lifting rope attached to the crane and used for lifting the crane to the attachment point,

FIG. 5 illustrates a wind turbine with an attached crane,

FIG. 6 illustrates an attached and unfolded crane,

FIG. 7 illustrates a crane with internal power means for lifting the crane,

FIGS. 8 and 9 illustrate the crane attached and unfolded,

FIG. 10 illustrates details of the load carrying structure and a guy wire for supporting the structure, and

FIGS. 11-31 illustrate mounting of the crane in a specific example by use of an interim crane.

### DETAILED DESCRIPTION OF THE DRAWINGS

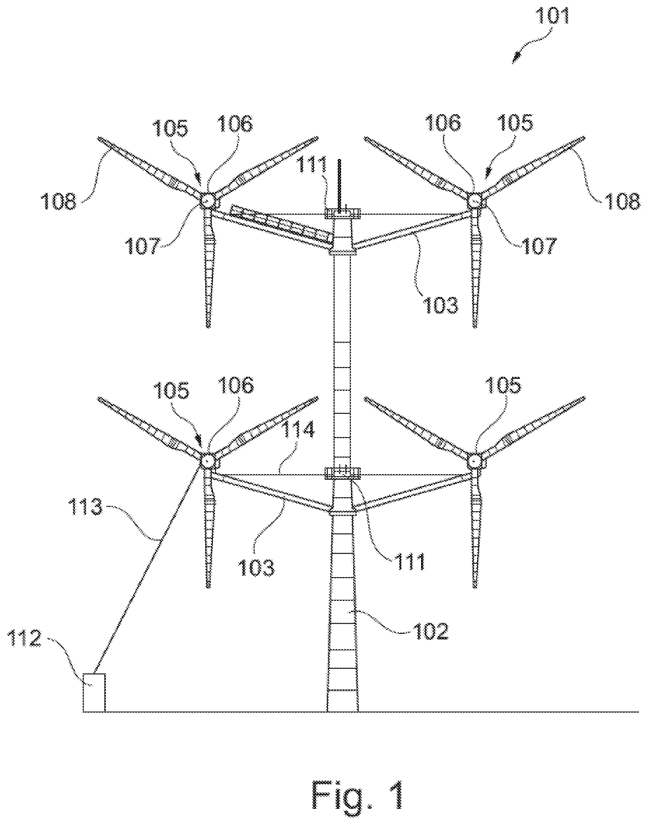

FIG. 1 illustrates a front view of a multirotor wind turbine 101 comprising a tower 102 carrying four load carrying structures 103. The load carrying structures 103 are arranged, in pairs of two, one pair above the other.

The load carrying structures in a pair of load carrying structures extend in opposite outwards directions away from the tower 102.

Each load carrying structure 103 supports an energy generating unit 105, and each energy generating unit 105 comprises a nacelle 106 and a rotor 107 carrying three wind turbine blades 108. Each energy generating unit 105 is connected to a load carrying structure via a rotational joint.

The load carrying structures 103 are attached to the tower 102 via a yaw arrangement 111, allowing the entire pair of load carrying structures to perform yawing movements with respect to the tower 102 in order to direct the rotors 107 into the incoming wind.

When the multirotor wind turbine 101 is operational, the energy generating units 105 are placed symmetrically around the tower 102 so that the multirotor wind turbine is balanced.

For maintenance and service, components 112 can be hoisted from ground to the nacelle by an internal hoisting rope 113 of an internal crane in the nacelle. The internal crane has very limited lifting capability.

The wind turbine comprises guy wires 114 attached either momentary for the purpose of supporting the load carrying structure while the crane is used or stationary, i.e. also after the crane is removed.

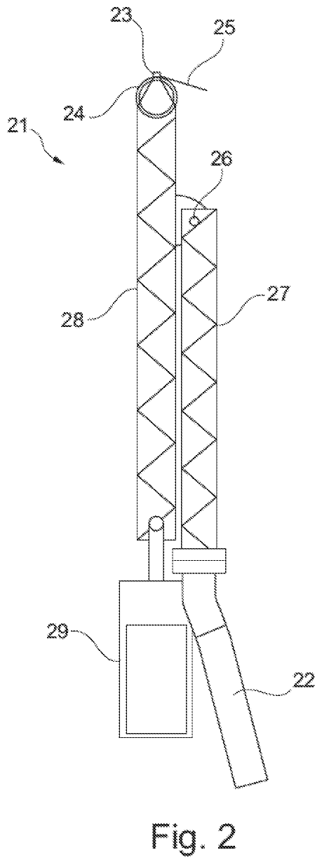

FIG. 2 illustrates a crane 21 which is configured for facilitating improved handling of components 112 in wind turbines. The crane is configured for being lifted to an attachment point and for releasable fixation to a wind turbine. The crane 21 comprises a fixation structure 22 configured for fixing the crane to the attachment point and a hoisting point 23 formed with a sheave 24 which guides a crane rope 25 and which can be used for lifting the wind turbine component to be handled. Between the fixation structure and the hoisting point, the crane forms a crane body. The crane body may particularly be a lightweight construction, e.g. a frame construction made of lightweight steel bars etc.

The crane body includes a hinge structure 26 which allows rotation of a first body part 27 relative to a second body part 28 and thus enables movement of the hoisting point 23 relative to the fixation structure 22.

In a front end of the second body part, the crane forms the illustrated hoisting point 23, in an opposite, second, end of the second body part, the crane forms a combined counterweight and control unit 29. The counterweight provides balance relative to the hinge structure 26 and thereby allows lifting of heavy components, and the control structure may include power driven means for driving the crane rope 25.

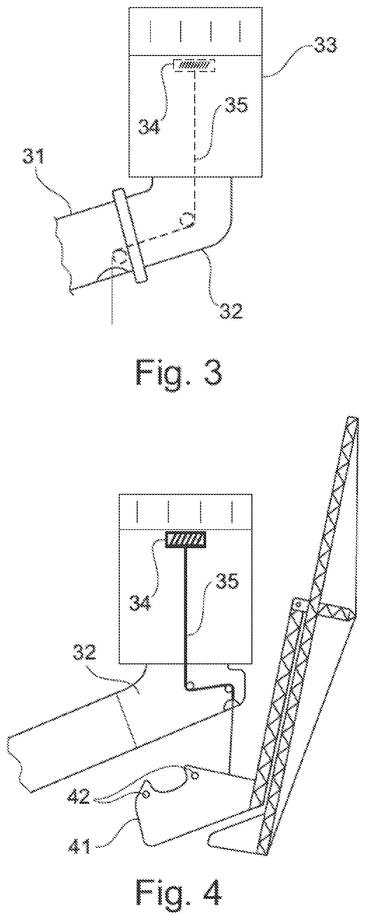

FIG. 3 illustrates a load carrying structure comprising a first part 31 and a second part 32. The first part is a hollow tubular element, and the second part is a casted component forming an interface to the energy generating unit 33. The casted component is stronger than the hollow tubular element and therefore suitable for carrying the load of the energy generating unit and the crane.

The energy generating unit 33 comprises an internal crane 34 handling a lifting rope 35. The lifting rope is thereby attached to the load carrying structure via the interface between the energy generating unit 33 and the load carrying structure 31, 32.

In FIG. 4, the lifting rope is attached to the crane and used for hoisting the crane from ground to the attachment point. FIG. 4 illustrates an embodiment where the fixation structure is configured to interface the load carrying structure in a predetermined orientation, and where the crane is provided such that it can be lifted with the lifting rope attached to the fixation structure and such that it is in balance in a balance orientation matching the predetermined orientation.

The attachment point is, in this embodiment, a lower section of the second part 32 of the load carrying structure.

The crane illustrated in FIG. 4 comprises a saddle shaped fixation structure 41 which matches the shape of the second part 32 of the load carrying structure, and due to the matching shapes, and the location of the lifting rope in the middle of the saddle, the saddle shape will guide the crane into the correct position on the load carrying structure.

FIG. 4 illustrates an embodiment wherein the fixation structure of the crane is configured for contact with the load carrying structure below a geometric centre of a cross section of the load carrying structure transverse to the outwards direction. Due to the saddle shape, the crane extends in contact with the load carrying structure from the point below the geometric centre to a point above the geometric centre where it is fixed by bolts via the bolt holes 42.

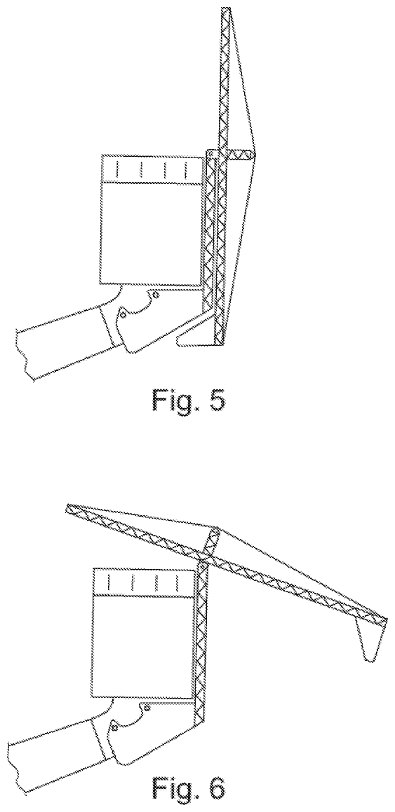

FIG. 5 illustrates the crane when it is attached and FIG. 6 illustrates when the crane is unfolded and ready to be used for handling large and heavy wind turbine components such as the entire energy generating unit or parts thereof.

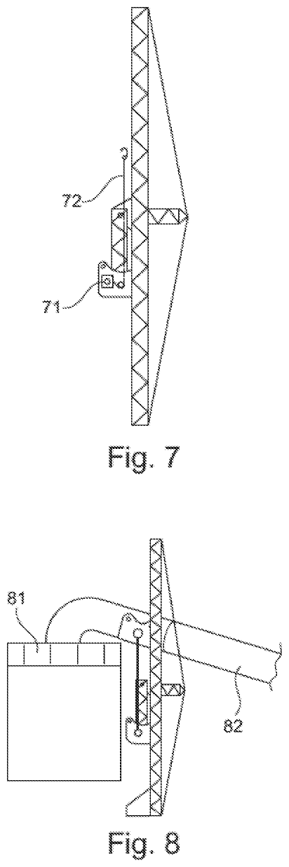

FIG. 7 illustrates a crane where the internal power driven means 71 for driving the crane rope 72 is used also for hoisting the crane in the process of attaching the crane to the load carrying structure. In this embodiment, the crane rope 72 may constitute the lifting rope. The crane rope may be lifted to the load carrying structure e.g. by use of a small internal crane in the energy generating unit.

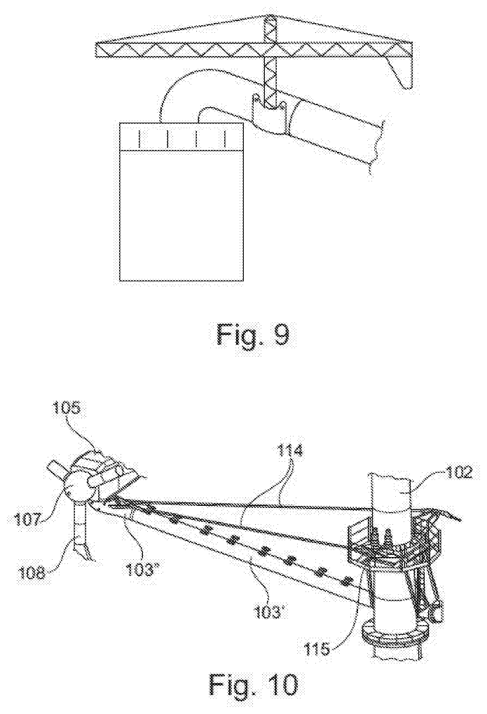

The crane illustrated in FIG. 7 has a fixation structure configured for attaching a load carrying structure of an upside-down type wind turbine where the energy generating unit 81 is attached below the load carrying structure. FIG. 8 illustrates the crane when attached to the load carrying structure 82, and FIG. 9 illustrates the crane when unfolded to an operational configuration.

FIG. 10 illustrates the load carrying structure 103, including a first part 103′ and a second part 103″, the second part forming an axial termination of the first part and terminates the load carrying structure furthest away from the tower 102. The first part is a hollow tube, and the second part is a casted component made of steel. The second part is therefore capable of withstanding larger impact and it can carry heavy components. The load carrying structure 103 acts as compression elements and it is supported by a tension element in the form of two guy wires 114 extending from a swivel arrangement 115 on the tower 102 to the second part 103″. The second part 103″ carries the energy generating unit 105 and is configured for carrying also the crane.

### Example 1

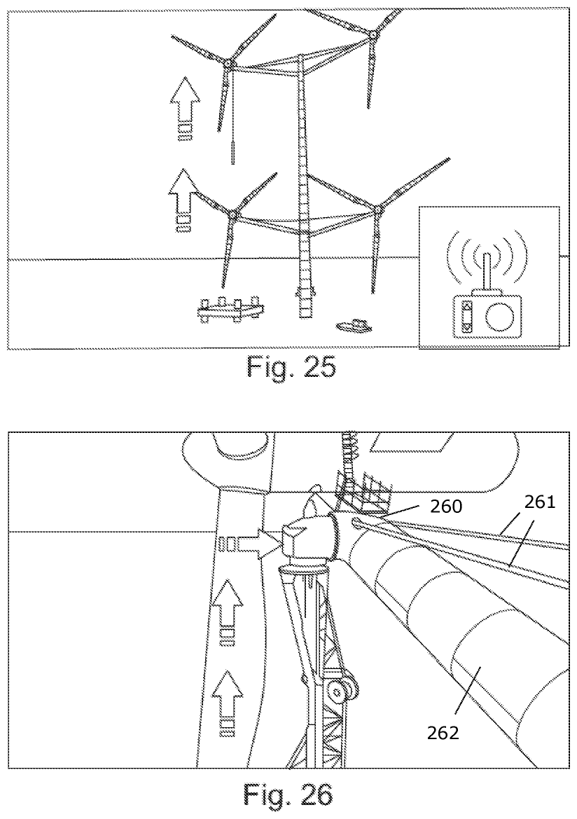

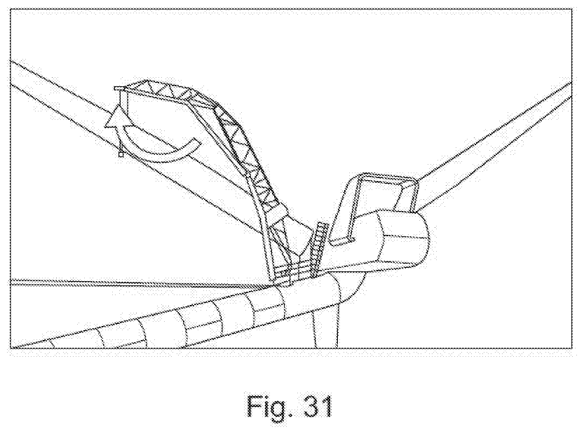

In the following, use of the crane will be described with reference to a specific example and with reference to the FIGS. 11-31. In this example, the wind turbine has only a very limited lifting capacity. The illustrated procedure therefore includes two steps, firstly lifting and attaching a small crane, and secondly, using the small crane to attach a larger crane.

When doing a replacement of main components, a small jack-up barge will carry both an interim crane and a larger crane which is to be used for handling the components to the turbine. FIGS. 11-14 illustrate a barge arriving at the wind turbine. The barge has no crane facility but carries the cranes which are to be fitted and used on the wind turbine. While the barge is being jacked-up, the technicians are loaded to the wind turbine.

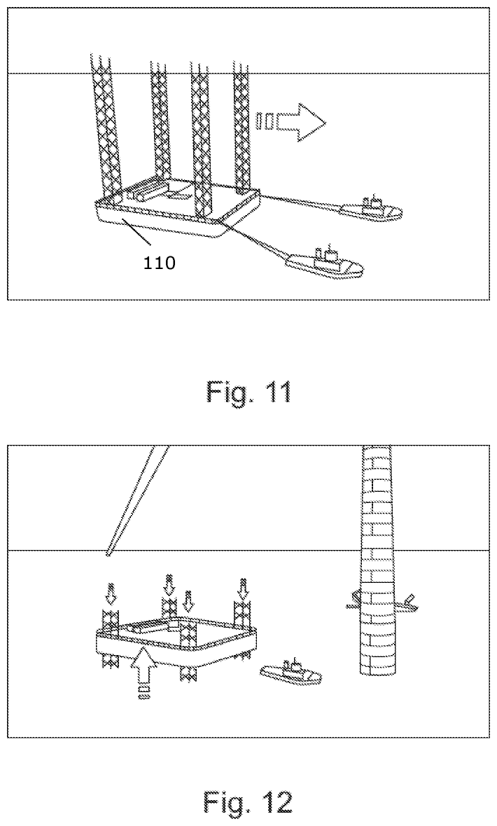

FIG. 11 illustrates a jack up barge 110 being transported to the site of the wind turbine in question. The barge contains a small crane to be attached for interim work on the wind turbine. FIG. 12 illustrates the barge being jacked up at the wind turbine site.

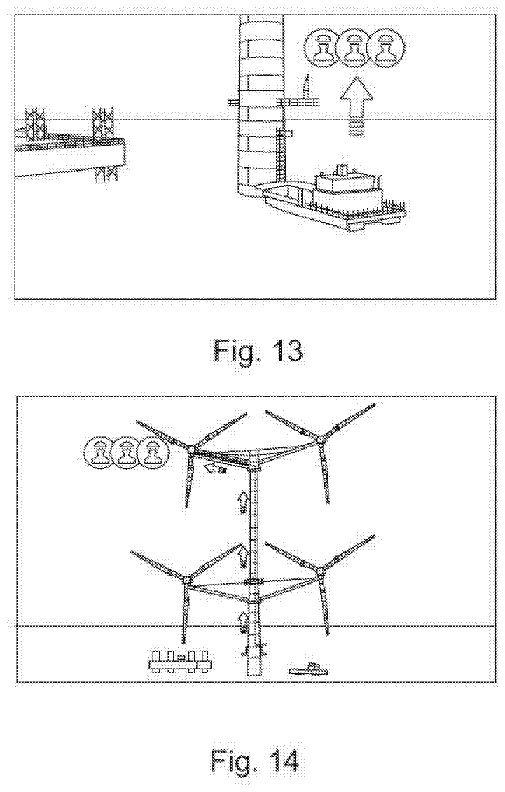

FIG. 13 illustrates the personnel enters the wind turbine, and FIG. 14 illustrates that the personnel enters the load carrying structure and the site where the crane is to be attached.

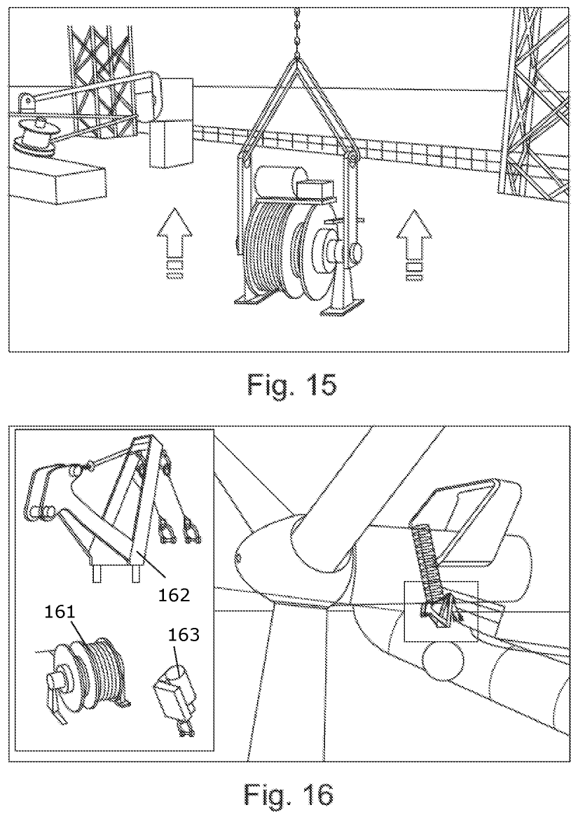

When the barge has been jacked up, a small interim crane, e.g. of the brand ‘Tirak’, will be lifted to the load carrying structure. This procedure is illustrated in FIGS. 15-18. In the specific example, the interim crane is attached to a part of the load carrying structure referred to as “the bell”. The bell is a solid, moulded component arranged in coextension to a hollow shaft and it forms an interface to energy generating unit. The fixed installation tool is unfolded, and the small crane is lead through the tool, where it will fetch the hook of the mobile crane.

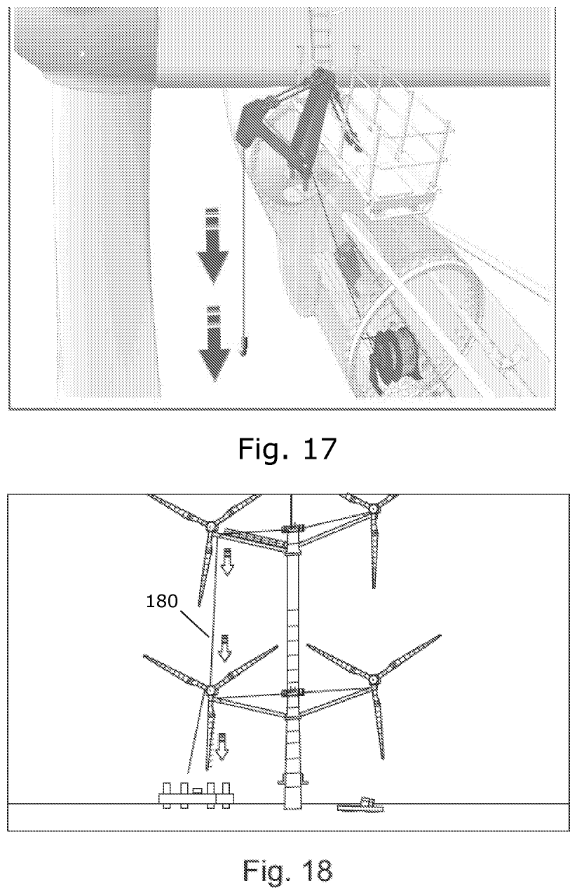

FIG. 15 specifically illustrates lifting of the winch part of a small interim crane. FIGS. 16 and 17 illustrate that the small crane is prepared on the load carrying structure. In the enlarged view of FIG. 16a, the components of the interim crane are shown. These are a power winch 161, a crane arm 162 and a lifting lug 163. FIG. 17 specifically illustrates that the power winch 161 is arranged in the bell and that the arm 162 is arranged outside the bell.

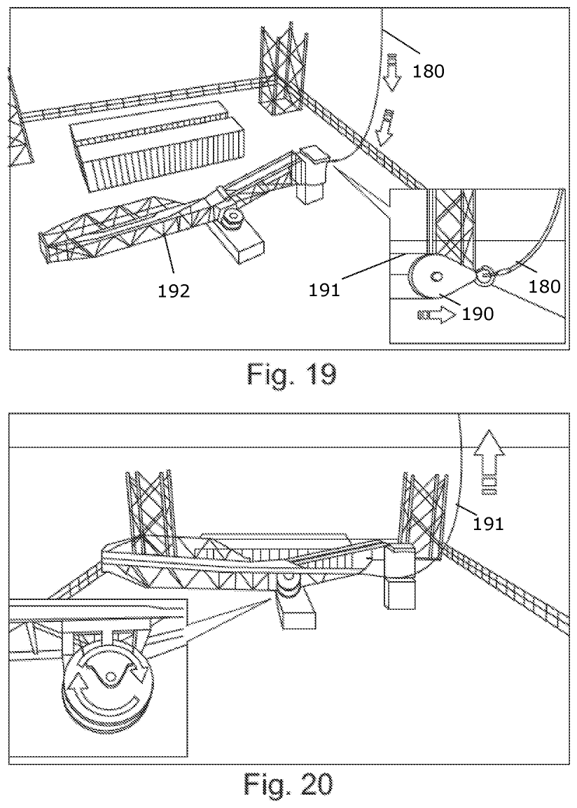

FIG. 18 illustrates that the wire 180 of the interim crane is lowered to the deck of the barge. At this moment, the small crane constitutes an internal crane with an internal lifting rope and will be referred to as an internal crane in the following. FIGS. 19-20 illustrate that the internal lifting rope 180 of the interim or internal crane is attached to the lifting lug 190 of the crane rope 191 of a crane 192 on the deck of the barge. The crane 192 on the deck of the barge is large relative to the internal or interim crane. The crane on the deck has a crane rope powered by a lifting power structure in the form of a powered winch. The crane rope is slackened, and the free end of the crane rope is connected to the internal lifting rope. The internal crane is subsequently applied for lifting the free end of the crane rope to the load carrying structure. This is illustrated in FIG. 19 so that only the crane hook and cable are lifted by the internal or interim crane.

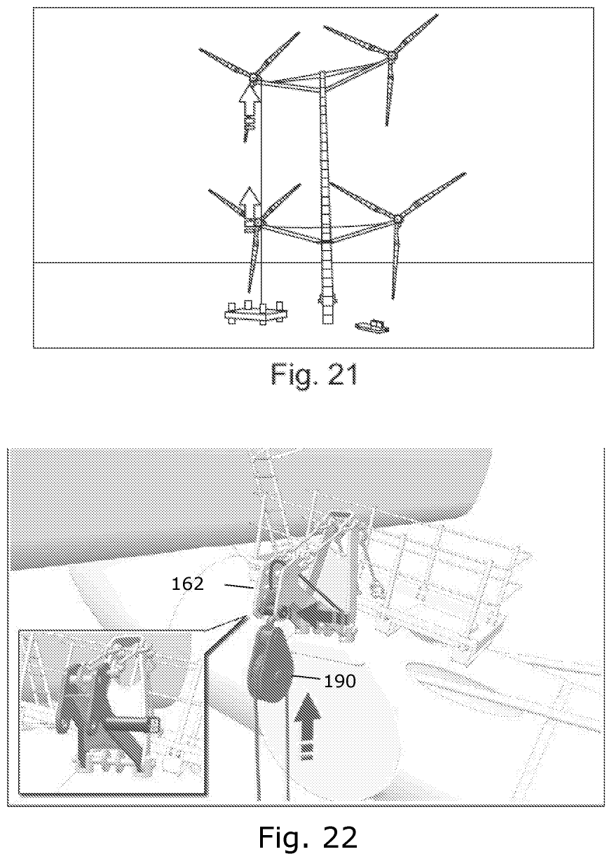

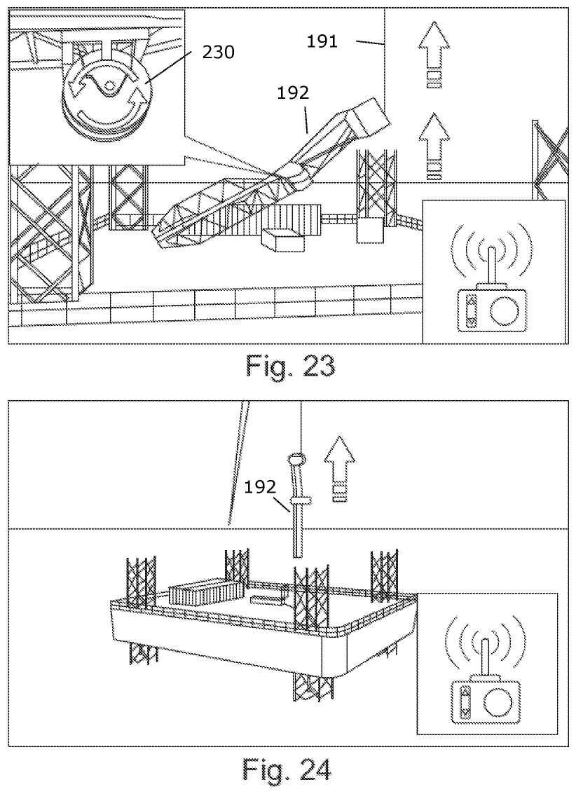

FIGS. 21-26 illustrate that the lifting lug 190 of the crane 192 is fixed to the load carrying structure. FIG. 22 specifically illustrates the lifting lug being fixed to the arm 162 of the interim crane. FIGS. 23 and 24 illustrate the crane 192 being lifted from the deck. In FIG. 23, it is illustrated that the crane rope 191 is winded up on the powered winch 230, and the crane 192 starts lifting itself, with the build in crane winch. The operation can be radio controlled by the personnel being at the load carrying structure. FIG. 26 illustrates that the crane 192 arrives at the load carrying structure. The Load carrying structure is constituted by the light weight arm 262, the relatively strong bell, 260, and the tension wires 261. FIG. 26 also clearly illustrates that the crane is thereby attached near the point where the tension wires 261 supports the load carrying structure.

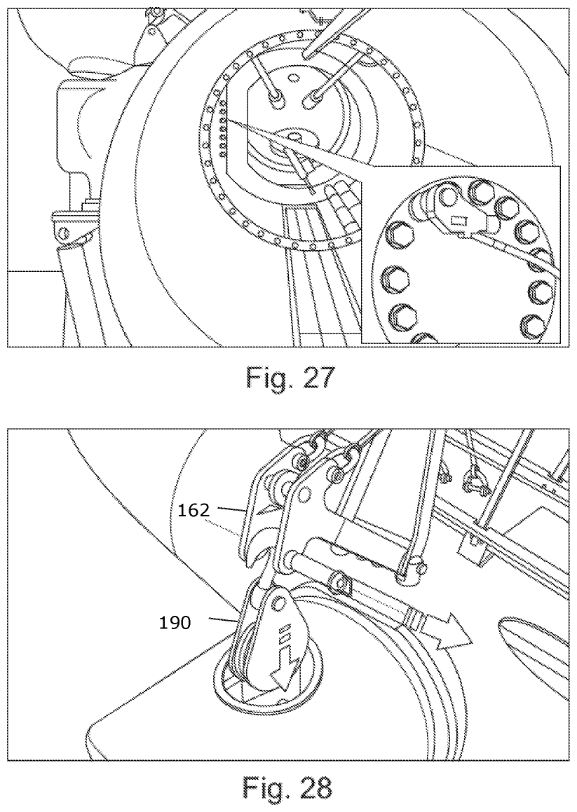

When the crane has reached the top, the crane is bolted to the load carrying structure from the inside, i.e. from inside the hollow part of this structure. This is illustrated in FIG. 27.

Following this procedure, the lifting lug 190 is released from the arm 162, c.f. FIG. 28. When the lifting lug 190 has been released, it can be used for lifting components which are to be handled.

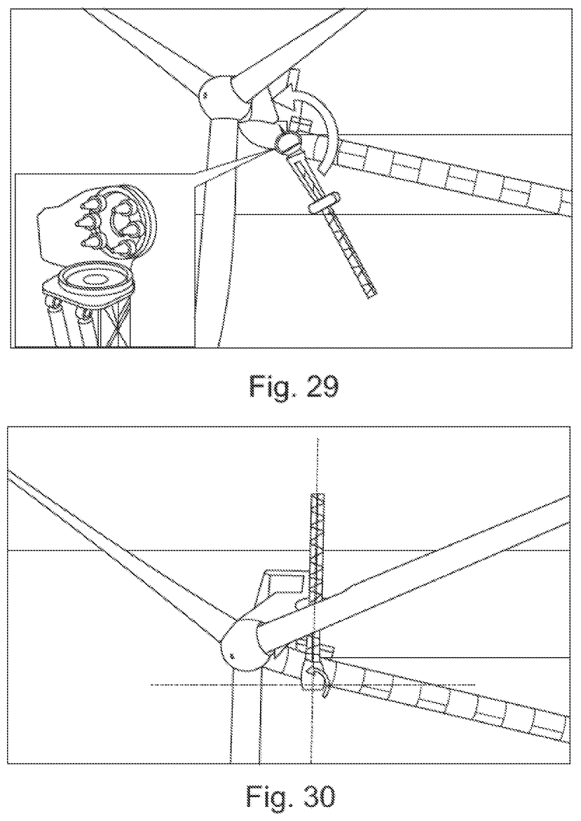

FIGS. 29-31 illustrate that the crane is fixed to the turbine and can operate therefrom. In the illustration, it is shown that the crane can rotate from a downwards position to an operational, upwards, position, by using a build-in yaw system.

When the crane has reached an upwards position, the crane will unfold, and is now ready to start lifting and handling components for the wind turbine.

1. A method of handling a wind turbine component in a multiple rotor wind turbine comprising a tower extending in an upwards direction, a load carrying structure fixed to the tower and extending in an outwards direction transverse to the upwards direction, and an energy generating unit fixed to the load carrying structure, the method comprising:
providing a crane with a fixation structure configured for fixing the crane to an attachment point on the load carrying structure or on the energy generating unit,
using a lifting rope attached to the load carrying structure or to the energy generating unit for hoisting the crane to the attachment point,
attaching the fixation structure of the crane to the attachment point, and
using the crane to handle the wind turbine component.

2. The method according to claim 1, wherein the crane is provided with a crane rope and a lifting power structure.

3. The method according to claim 1, wherein the crane rope constitutes the lifting rope, and wherein the lifting rope is lifted to the load carrying structure or to the energy generating unit by use of an internal or interim crane at the load carrying structure or at the energy generating unit.

4. The method according to claim 2, wherein the crane is lifted by the crane rope constituting the lifting rope by use of the lifting power structure included in the crane.

5. The method according to claim 1, wherein the lifting rope is attached to the fixation structure.

6. The method according to claim 5, wherein the fixation structure is configured to interface the load carrying structure in a predetermined orientation.

7. The method according to claim 6, wherein the crane is provided such that it can be lifted with the lifting rope attached to the fixation structure and such that it is in balance in a balance orientation matching the predetermined orientation.

8. The method according to claim 1, wherein the crane is configured to form contact with the load carrying structure below a geometric centre of a cross section of the load carrying structure transverse to the outwards direction.

9. The method according to claim 8, wherein the crane is provided such that it extends in contact with the load carrying structure from the point below the geometric centre to a point above the geometric centre.

10. The method according to claim 1, wherein the crane is provided with a hoisting point forming a point of suspension of a crane rope.

11. The method according to claim 10, wherein the crane is provided such that the position of the hoisting point is movable relative to the position of the fixation structure.

12. The method according to claim 1, wherein the energy generating unit is lifted by use of the crane.

13. The method according to claim 1, wherein the load carrying structure is supported by at least one tension element extending from the tower to the attachment point.

14. The method according to claim 1, wherein a tagline is connected to the crane when the crane is lifted by the lifting rope.

15. The method according to claim 1, wherein an extension component is lifted by use of the crane, and wherein a structure of the crane is subsequently extended by use of the extension components.

16. The method according to claim 1, wherein a further crane is lifted by use of the crane, the further crane being fixed to the load carrying structure.

17. The method according to claim 1, wherein the crane is released from the load carrying structure and lowered by use of the lifting rope or the crane rope.

18. The method according to claim 1, comprising the step of attaching at least one guy wire between the tower and a support point in the vicinity of the attachment point.

19. The method according to claim 1, wherein the load carrying structure comprises at least a first and a second component, the second component being connected to the first component and having a higher strength than the first component, wherein the attachment point is a point on the second component.

20. The method according to claim 1, wherein the load carrying structure comprises at least a first and a second component, the first component not being casted, and the second component being connected to the first component and being casted.

21. The method according to claim 1, wherein the load carrying structure comprises at least a first and a second component, the second component being casted and having a connection interface to the first component and the energy generating unit being attached to the second component.

22. The method according to claim 21, wherein the energy generating unit is attached to the second component via an adapter.

23. The method according to claim 22, wherein the attachment point is a point on the second component.

24. The method according to claim 21, comprising the step of attaching at least one tension element between the tower and a support point on the second component.

25. The method according to claim 1, wherein the crane is hoisted in one single hoisting procedure and in one piece.

26. The method according to claim 1, wherein several pieces of the crane is hoisted in several subsequent hoisting procedures.

27. A wind turbine comprising a tower extending in an upwards direction, a load carrying structure extending in an outwards direction and being fixed to the tower, and an energy generating unit fixed to the load carrying structure, wherein the outwards direction is transverse to the upwards direction, the wind turbine further comprising a crane attached to an attachment point of the load carrying structure or on the energy generating unit.

28. The wind turbine according to claim 27, wherein the load carrying structure comprises at least a first component and a second component, the second component forming an axial termination of the first component and having a higher strength than the first component, wherein the attachment point is a point on the second component.

29. The wind turbine according to claim 27, wherein the load carrying structure comprises at least a first component and a second component, the second component being casted and having a connection interface to the first component and forming an interface to the energy generating unit.

30. The wind turbine according to claim 28, comprising at least one tension element extending between the tower and a support point on the second component.
